(19) United States
(12) Patent Application Publication
(10) Pub. No.: US 2025/0174064 A1
(43) Pub. Date: May 29, 2025

(54) TRACKING LOCATION HISTORY VIA ACCESS CONTROL DEVICES

(71) Applicant: Google LLC, Mountain View, CA (US)

(72) Inventors: Steve Sunghwan Paik, Renton, WA (US); Cynthia Chenxin Kim, Los Altos, CA (US); Ross Fergus Hewit, Sammamish, WA (US); David Edward William Mercer, Poulsbo, WA (US)

(21) Appl. No.: 18/523,395

(22) Filed: Nov. 29, 2023

(51) Int. Cl. G07C 9/27

(52) U.S. Cl. CPC G07C 9/27

(57) ABSTRACT

Systems and methods for tracking location history via access control devices. Information identifying a location of the access control device is received by a user client from an access control device. An identifier of the location of the access control device, as well as a timestamp referencing a current time, are stored on the user device. A request of a user of the user device, for a list of locations visited within a specified time window, is received at the user device. Responsive to determining that the timestamp belongs to the specified time window, the identifier of the location is visually represented via a graphical user interface rendered on the user device.

### TECHNICAL FIELD

Aspects and implementations of the present disclosure relate to access control, and in particular to tracking location history via access control devices.

### BACKGROUND

In the realm of physical security and access management, controlling entry to restricted areas is an important component for many organizations, encompassing various settings from corporate offices to secure government facilities. Many access control systems typically rely on access control devices, which can include magnetic card readers, keypads, or biometric scanners, to authenticate an individual's identity and determine their access privileges.

Mobile devices can often be used to gain access to a restricted area via an access control device. Throughout a typical day, mobile devices can accumulate a variety of types of data, ranging from business communications and confidential documents to scheduling information and location data. For example, location data can be acquired through global positioning systems (GPS), cell tower triangulation, wi-fi positioning, IP address location, and/or other technologies and methods. Current systems often fail to effectively integrate, analyze, and protect this data in a manner that optimally balances productivity, user privacy, and data security.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In some implementations, a system and method are disclosed for tracking location information via access control devices. In an implementation, a method includes receiving, by a processor of a user device, from an access control device, information identifying a location of the access control device. The method further includes storing, on the user device, an identifier of the location of the access control device, and a timestamp referencing a current time. The method further includes receiving, at the user device, a request of a user of the user device for a list of locations visited within a specified time window. The method further includes, responsive to determining that the timestamp belongs to the specified time window, visually representing the identifier of the location via a graphical user interface (GUI) rendered on the user device.

In some implementations, visually representing the identifier of the location via the GUI rendered on the user device can include identifying a plurality of identifiers of locations stored on the user device with timestamps belonging to the specified time window, and displaying a user interface in the GUI with the identified plurality of identifiers comprising the identifier of the location of the access control device.

In some implementations, the information identifying the location of the access control device includes an access control device ID, a serial number of the access control device, a latitude and longitude coordinate, and/or a geolocation code.

In some implementations, the method further includes updating location data of the user device to correspond to the information identifying the location of the access control device.

In some implementations, receiving, from the access control device, the information identifying the location of the access control device further includes sending, to the access control device, a first request to access the access control device. The method further includes receiving, from the access control device, a message comprising an application ID of an application, hosted by the user device, to communicate with the access control device, and the information identifying the location of the access control device. The method further includes receiving, from the access control device, a second request for an identification of the user device. The method further includes, responsive to the second request, sending, to the access control device, a user identification associated with the user device. The method further includes receiving, from the access control device, a nonce; generating a signed nonce by signing the nonce with a private key. The method further includes sending the signed nonce to the access control device to allow the access control device to authenticate the user device.

In some implementations, receiving, from the access control device, the information identifying the location of the access control device further includes sending, to the access control device, a first request to access the access control device. The method further includes receiving, from the access control device, an application ID of an application, hosted by the user device, to communicate with the access control device. The method further includes receiving, from the access control device, a second request for an identification of the user device. The method further includes, responsive to the second request, sending, to the access control device, a user identification associated with the user device. The method further includes receiving, from the access control device, a nonce with the information identifying the location of the access control device. The method further includes generating a signed nonce by signing the nonce with a private key. The method further includes sending the signed nonce to the access control device to allow the access control device to authenticate the user device.

In some implementations, receiving, from the access control device, the information identifying the location of the access control device further includes sending, to the access control device, a first request to access the access control device. The method further includes receiving, from the access control device, an application ID of an application to communicate with the access control device, wherein the application is hosted by the user device. The method further includes receiving, from the access control device, a second request for an identification of the user device. The method further includes, responsive to the second request, sending, to the access control device, a user identification associated with the user device. The method further includes receiving, from the access control device, a nonce. The method further includes generating a signed nonce by signing the nonce with a private key. The method further includes sending the signed nonce to the access control device to allow the access control device to authenticate the user device. The method further includes receiving, from the access control device and using the application, an application protocol data unit comprising the information identifying the location of the access control device.

In some implementations, the method further includes sending the information identifying the location of the access control device to a second application hosted by the user device. The method further includes receiving, from the second application, additional data corresponding to the location of the access control device. The method further includes providing the additional data for display in the GUI rendered on the user device.

An aspect of the disclosure provides a system including a memory device and a processing device communicatively coupled to the memory device. The processing device performs the method as described above.

An aspect of the disclosure provides a computer-readable storage medium (which may be a non-transitory computer-readable storage medium, although the disclosure is not limited to that) stores instructions which, when executed, cause a processing device to perform the method as described above.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with at least one embodiment of the present disclosure.

FIG. 2 is a diagram illustrating an implementation of a method to enable communication between a user device and an access control device, in accordance with at least one embodiment of the present disclosure.

FIG. 3 is a flow diagram of an example method for tracking location information by a user device, in accordance with at least one embodiment of the present disclosure.

FIG. 4 is a block diagram illustrating an exemplary computer system, in accordance with at least one embodiment of the present disclosure.

### DETAILED DESCRIPTION

Aspects of the present disclosure relate to tracking location history via access control devices. An access control device can refer to a system or mechanism used to manage entry into a particular space or to use a specific resource. One purpose of an access control device can be to provide selective restriction of access to a location or other resource, allowing access to authorized individuals and preventing access to unauthorized individuals. An access control device can include, for example, an authentication mechanism (e.g., a keypad, a card reader, a biometric system), a physical barrier (e.g., a door, a turnstile, a gate), electronic components (e.g., a control panel, a sensor or alarm), software to manage the device (e.g., configure permissions, view access logs, and/or monitor access points), communication network, identification methods, and/or a power supply. Access control devices may operate on standalone systems (e.g., a single-door access), or be part of a complex networked system across multiple entry points.

Some access control devices can receive credential information from a mobile device, such as a user's mobile phone. Thus, a user can gain access to a particular location or resource using their mobile device. For example, a user's device can use Bluetooth®, near field communication (NFC), Wi-Fi, and/or another communication protocol to gain access to a particular location or resource restricted by an access control device. The user device and the access control device can perform a secure authentication process, in response to which the access control device can determine whether to grant access. However, once the secure authentication process has been performed and the access control device has granted (or denied) access to the user device, the user device does not store information related to the authentication process. For example, if the user visited several locations (e.g., several buildings and/or rooms on a college campus or a company campus) having different access control devices that authenticated the user device to allow the user to access these locations, information about the locations is not stored on the user device, and the user is not able to easily track their locations during a particular day or time. Thus, the user device does not benefit from the authentication process performed to gain access via an access control device.

Aspects of the present disclosure address the above-noted and other deficiencies by tracking a user device's location history using access control devices. In some embodiments, a user entering a restricted area can request access from an access control device using their mobile device. The mobile device can be, for example, a smart phone, a smart watch, or any other mobile device that can communicate with the access control device. The access control device can use near field communication, Bluetooth, radio-frequency identification (RFID), and/or another type of communication protocol to communicate with the user's mobile device.

In some embodiments, the access control device can be a reader device or another similar access control device configured with an authentication sequence that not only authenticates the user device, but also provides location data to the user device. The authentication sequence can be based on a set of predefined operations including, for example, providing an application ID to the user device to communicate with the user device, providing the user device with a nonce for the user device to sign using a private key, and/or providing the user device with a data unit or message (such as, in the form of an application protocol data unit (APDU)). With embodiments of the present disclosure, the set of predefined operations can involve including information identifying the location of the access control device in the application ID, the nonce, and/or the message (e.g., the APDU). The information identifying the location of the access control device can be, for example, an access control device ID, a serial number of the access control device, a latitude and longitude coordinate, a geolocation code, or any other information that can be used to identify the location of the access control device.

In some embodiments, the user device can store the information identifying the location of the access control device (sometimes referred to simply as “location information”). The user device can also store a timestamp that indicates the date and time (or optionally only the time) that the location information was received from the access control device. In some embodiments, the timestamp can reference the time the location information was stored on the user device. The user device can maintain a list of access control devices accessed by the user device, along with corresponding timestamps for each access granted. In some embodiments, the user device can also maintain access attempts and their corresponding timestamps, even if the access was denied. For example, the list of access control devices can have a corresponding timestamp and a corresponding access status (e.g., access granted, access denied).

In some embodiments, a user of the user device can request a list of locations accessed within a specified time window. The user can submit a request via a graphical user interface (GUI), indicating the time window. The request can optionally include a location area. For example, the user can request a list of locations accessed within the specified time window for a certain building on a campus. The user device can identify the location(s) of the access control devices that fall within the specified time window, and visually provide a list of the information identifying the access control device(s) via the GUI rendered on the user device. In some embodiments, the visual representation can include an access status along with the location information and the timestamp.

In some embodiments, the user device can provide the information identifying the location of the access control device(s) accessed to a secondary application hosted by the user device. The secondary application can be an application that the user has enabled to access their location history. The secondary application can use the location history of the user device, collected from communications with various access control devices, in the execution of the application. As an illustrative example, the secondary application can be an activity tracker, and it can use the location history of the user device to track the distance that a user has walked. In some embodiments, the secondary application can combine the location history information collected from various access control devices with the location data collected using other methods (such as GPS, wi-fi, cell tower triangulation, etc.) to generate secondary data. As an illustrative example, the secondary application can determine an estimated mode of travel (e.g., walk, run, bike, drive), based on the distance between locations and the time elapsed for the user to travel between locations, and can generate secondary data according to the functionality of the secondary application (e.g., create a recommendation of an activity to log in the activity tracker). As another illustrative example, the secondary application can use the location information collected from access control devices to determine that the user device accessed a gym or a cafeteria, and can use this information to remind the user to log their gym workout or meal. The secondary application can be any type of application that can use location information for its intended purpose.

In some embodiments, the user device can use the information identifying the location of the access control device to calibrate the location data of the user device. A user device can keep track of its location throughout the day, often through technology such as GPS, cell tower triangulation, wi-fi positioning, Bluetooth and beacon technology, inertial sensors, and/or IP address location. While these technologies provide a rough estimate of the device's location, they may not consistently provide an accurate indication of the precise location of the user device. However, when a user device receives specific location information corresponding to a physical access control device at which the user device is located, the user device can use this specific and precise location information to calibrate the location of the user device. For example, while some location technologies can indicate that the user device is located at a specific address, the location information from an access control device can specify the floor of the building, and at which entry point the user device is located. This location information can be much more specific and reliable than location information provided by current location tracking technologies. As another example, the location information received from an access control device can specify a specific room that the user is attempting to access. The user device can use this location information to calibrate its location data, even if the access control device denied access to the user device.

Aspects of the present disclosure provide technical advantages over previous solutions. Some of the technical advantages of the present disclosure includes enhanced data privacy, reduced data storage on a server device, and improved location calibration for mobile devices. By storing location history information on the mobile device itself, rather than on a server device, aspects of the present disclosure reduce the storage resources used to store such data on a server device. This can alleviate undue stress on the storage resources, as well as the computing resources consumed to send data to and from the server device. Additionally, by storing a user's location history data locally on the user's mobile device, aspects of the present disclosure can provide for enhanced data privacy and data security. Many common threats to data privacy and security are caused by an attack on a data center, which can store personal data of multiple users. A data center can include, for example, multiple server devices in a cloud computing environment. Storing the location information of a user device locally on the user device, and not in a data center, can help ensure that the data is not vulnerable to intrusive activity directed to the data center. Additionally, a user can have more control over their location history data, by having direct access to the locally stored data.

Aspects of the present disclosure can also be used to calibrate the location data of a user device. The location information received from an access control device can be more precise and specific than the conventional location tracking technologies used to identify the location of the user device (e.g., GPS, cell tower configuration, wi-fi positioning, etc.). The user device can use the location information received from an access control device to update the location data stored locally on the user device. Calibrating the user device's location data to a more accurate, precise and specific location based on the location information received from the access control device can improve the functionality of the user device itself, and the applications hosted by the user device. For example, location tracking can be crucial for emergency services, and thus tracking the specific location of the user device can help in emergency situations. As another example, many location-based applications hosted by the user device can benefit from more accurate location tracking, such as navigation, maps, parental controls and security (e.g., locating a lost device), integration with IoT devices (e.g., smart home integration), etc. Precise and accurate location tracking can improve the overall efficiency of such applications, as the applications will not need to repeatedly request updated location information from more generic location technologies (e.g., GPS, cell tower triangulation, etc.). Thus, the overall efficiency of user devices implementing such applications is improved.

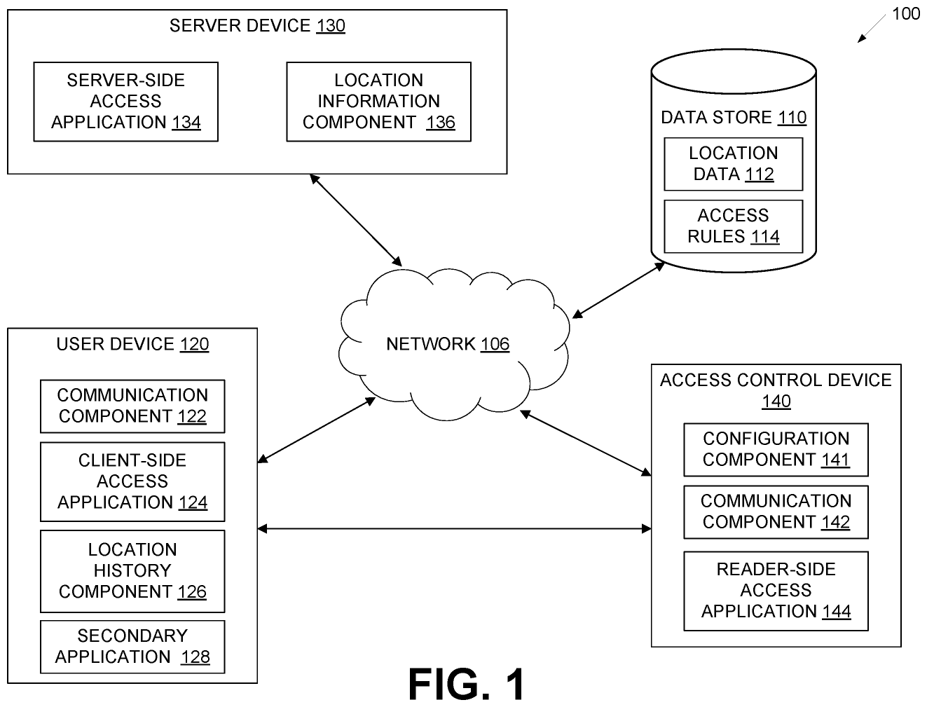

FIG. 1 illustrates an example system architecture 100, in accordance with at least one embodiment of the present disclosure. The system architecture 100 includes one or more user devices 120, an access control device 140, a data store 110, and/or a server 130, each connected to a network 106. In some embodiments, user device 120 can communicate directly with access control device 140 without using network 106. For example, user device 120 and access control device 140 can communicate via Bluetooth, NFC, RFID, and/or some other wireless communication protocol that does not require a network connection. Network 106 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some embodiments, data store 110 is a persistent storage that is capable of storing location data 112 and/or access rules 114, as well as data structures to tag, organize, and index the stored data. Data store 110 may be hosted by one or more storage devices, such as main memory, magnetic or optical storage based disks, tapes or hard drives, NAS, SAN, and so forth. In some implementations, data store 110 may be a network-attached file server, while in other embodiments data store 110 may be some other type of persistent storage such as an object-oriented database, a relational database, and so forth, that may be hosted by server device 103, access control device 140, and/or user device 120. In some embodiments, data store 110 may be hosted by or one or more different machines coupled to the server 130, access control device 140, and/or user device 120. In some embodiments, location data 112 can store location information for one or more access control devices 140. The location information stored in location data 112 can include, for example, access control device identifier(s) (IDs), serial numbers of access control device(s), latitude and longitude coordinates of corresponding access control device(s), geolocation codes of corresponding access control device(s), and/or any other information that can provide location information of a specific access control device. For example, location data 112 can be a table, and each record in the table can store an access control device ID, a serial number of the access control device, latitude and longitude coordinates of the physical location of the access control device, geolocation code of the physical location of the access control device, an address of the physical location of the access control device, and/or any other location information indicating the physical location of the access control device. In some embodiments, user device 120 and/or access control device 140 can use the information stored in location data 112 to determine the location of the access control device 140. The access rules 114 can store rules corresponding to providing access to a user device 120 to various access control devices 140. The access rules can include, for example, a list of user identifiers and corresponding access privileges for specific access control devices 140 (e.g., a list of user identifiers that have access privileges, a schedule of when certain user identifiers have and/or do not have access privileges, etc.). In some embodiments, the access rules 114 can include authentication data, such as public-private key pairings used to authenticate user device 120. In some embodiments, at least some of the access rules 114 can be stored directly on access control device 140, such that access control device 140 can provide access to a user device 120 without accessing network 106.

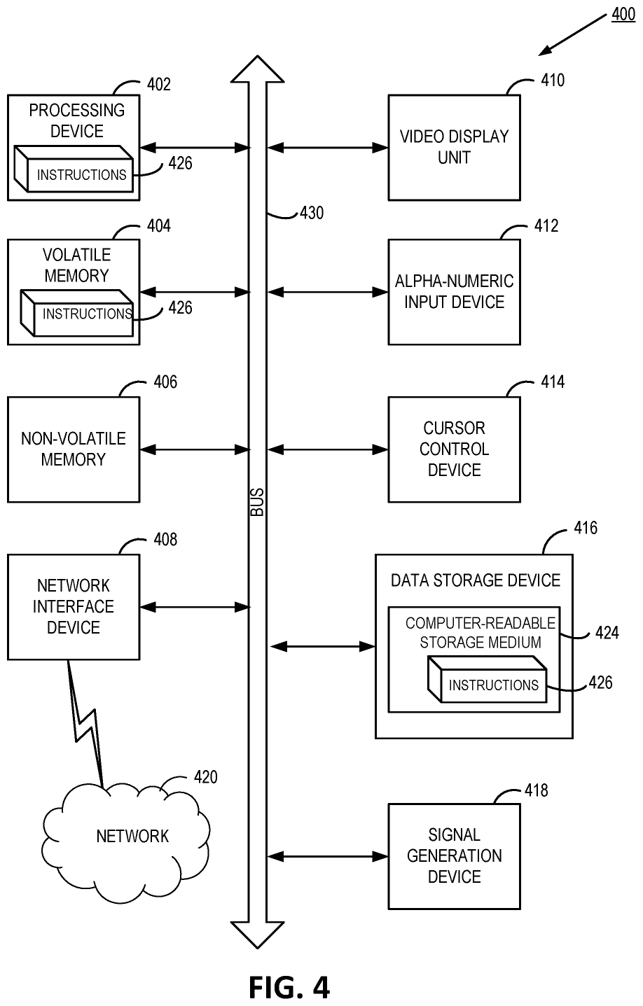

User device 120 can be a mobile computing device, such as mobile phones, smart devices (smart phones, smart watches, etc.), tablet computers, netbook computers, digital assistants, Internet of Things (IoT) devices, or any other computing devices capable of communicating with an access control device 140. FIG. 4 illustrates an example architecture of a user device 120. In some embodiments, user device 120 can also be referred to as a “client device.”

An access control device 140 can be a device that, when presented with valid credentials, enables access to a secure area. For example, the access control device 140 can be placed next to a locked door in a building, and when presented with valid credentials, can cause the door to be unlocked for a short period of time. In some embodiments, the lock on the door can be an electronic lock that can be unlocked via a signal received from the access control device 140. In some embodiments, the access control device 140 can include a card reader, a keypad, and/or a biometric system to verify a user's identity. For example, the biometric system can utilize fingerprint(s), facial recognition, iris scan(s), and/or voice recognition to verify a user's identity. The access control device 140 can include a control panel that houses a central processing unit that can execute software for the access control system. The central processing unit can carry out the functions of the configuration component 141, the communication component 142, and/or the reader-side access application 144. In some embodiments, the access control device 140 can include one or more sensor(s) and/or alarm(s) to detect unauthorized access or attempts at tampering with the access control device 140 and/or the door to which the access control device 140 provides access. In some embodiments, the access control device 140 can be part of a networked access system that includes multiple access control devices 140 (e.g., located throughout a building or campus). For example, each of the multiple access control devices 140 can provide access to a unique entry point to the building and/or campus. In some embodiments, network access control device 140 can be integrated into a system that also includes surveillance cameras, alarms, and/or other security features.

In some embodiments, the communication component 142 of the access control device 140 can provide wired or wireless communication with a user device 120, and/or with the physical barrier to which it is controlling access (e.g., a locked door). In some embodiments, the communication component 142 can enable wireless communication with a user device 120 by implementing a communication protocol, such as Wi-Fi, Bluetooth, RFID, NFC, etc. The communication component 142 can enable the transfer and receipt of data and/or commands with user device 120. In some embodiments, the communication component 142 can send and receive data and/or commands directly to and from user device 120. In some embodiments, the communication component 142 can send/receive data and/or commands to/from user device 120 via network 106. In some embodiments, communication component 142 can send an instruction to the electronic lock of the door to which it is providing access control. The instruction can cause the electronic lock to unlock for a period of time. The period of time can be enough to allow the user of user device 120 to open the door. The period of time can be, for example, 5 seconds.

In some embodiments, the configuration component 141 can receive a configuration file from server device 130. The configuration file can configure the settings and/or parameters of reader-side access application 144. The configuration file can include instructions to embed the location information of the access control device 140 in communications with the user device 120. For example, the location information of the access control device 140 can be included in a message set to the user device 120 during the authentication process carried out by reader-side access application 144 and the client-side access application 124. The configuration file can specify how the access-side access application 144 is to send location information to the client device 120. Examples of how the access-side access application 144 can send location information to the client device 120 includes embedding the location information in a nonce during the authentication process, adding the location information to the application ID (e.g., sent in a select command), or sending the location information in a message (e.g., establishing a new application protocol data unit (APDU) that includes the location information). The configuration component 141 can receive the configuration file from server device 130, and can implement the instructions in the configuration file, thus establishing a method with which to transfer location information to user device(s) 120.

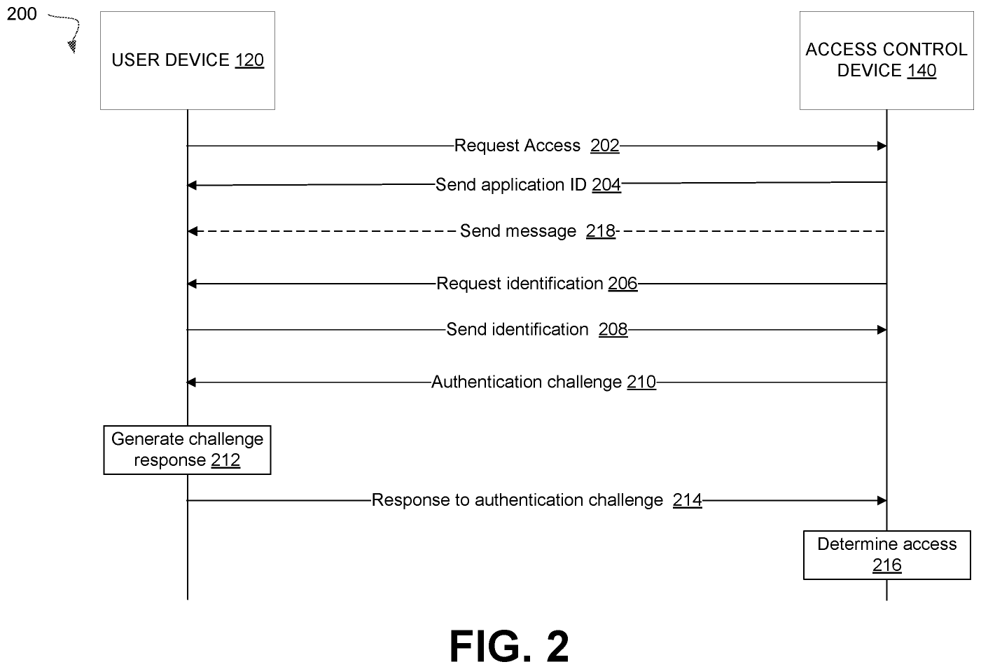

In some embodiments, the reader-side access application 144 of the implement an authentication protocol with user device 120. In some embodiments, access control device 140 can receive credential information from communication component 142. The reader-side access application 144 can determine whether to provide access to the user device 120 based on the received credential information. The reader-side access application 144 can implement a number of methods to determine whether to grant access to user device 120. The communications between the reader-side access application 144 and the client-side access application 124 is further described with respect to FIG. 2.

A user device 120 can include a communication component 122, a client-side access application 124, a location history component 126, and/or a secondary application 128. In some embodiments, the communication component 122 can establish a communication protocol for communicating with access control device 140. The communication protocol can implement, for example, NFC, Bluetooth, wi-fi, and/or any other type of communication protocol. The communication component 122 can send a request to access control device 140. For example, using NFC, the communication component 122 can send a request to the access control device 140 in response to the user device 120 being within a certain distance from the access control device 140 (e.g., 4 centimeters). The communication component 142 of access control device 140 can respond to the request by sending the application ID to the user device 120. The application ID can be sent as part of a select command, which instructs the user device 120 to select the application corresponding to the application ID to facilitate communication with the access control device 140. The application ID can reference client-side access application 124. Thus, the user device 120 can launch client-side access application 124. In some embodiments, the location information can be embedded as part of the select command. For example, the application ID can be extended to include the location information.

In some embodiments, the client-side access application 124 can receive data, messages, and/or commands from the reader-side access application 144. The data, messages, and/or commands can include location information of the access control device 140. The client-side access application 124 can extract the location information from the received data, messages, and/or commands, and can store the extracted location information along with a timestamp corresponding to the time at which the location information was received. In some embodiments, the client-side access application 124 and the reader-side access application 144 can perform an authentication process, through which the location information of the access control device 140 can be sent to the user device 120. For example, the location information can be embedded in a nonce generated by reader-side access application 144 and sent to client-side access application 124. The client-side access application 124 can extract the location information from the nonce, generate a signed nonce, and send the signed nonce to the reader-side access application 144 to allow the access control device 140 to authenticate the user device. As another example, the location information can be included in a message (e.g., an APDU) sent by the reader-side access application 144. The client-side access application 124 can receive the message (e.g., the APDU) and can identify and/or extract the location information from the APDU. In some embodiments, the client-side access application 124 can respond with a response APDU, indicating the status of the response (e.g., whether the user device successfully extracted and/or stored the location information). The exchange of information between the user device 120 and the access control device 140 is further described with respect to FIG. 2. In some embodiments, the client-side access application 124 can send the location information to location history component 126.

In some embodiments, the location history component 126 can store location information corresponding to access control device(s) 140 with which the user device 120 has communicated, and the corresponding timestamp(s) indicating the time(s) that location information was received from the access control device(s) 140. In some embodiments, the location history component 126 can cause the user device 120 to store location information data for each access control device 140 with which the client-side access application 124 has communicated. The location information stored at user device 120 can include, for example, the access control device 140 identifier (e.g., the serial number of the access control device, the access control device ID), and/or the information identifying the location of the access control device 140 (e.g., latitude and longitude coordinates of the physical location of the access control device 140, a geolocation code of the physical location of the access control device 140, an address of the physical location of the access control device 140, and/or any other information identifying the physical location of the access control device 140). The location information stored at user device 120 can include an access status, e.g., indicating whether access was granted or denied. The location information stored at user device 120 can include a timestamp corresponding to the communication with the access control device 140. In some embodiments, the timestamp can reflect the time at which the access status was determined (e.g., the time at which access was granted or denied). In some embodiments, the location history component 126 can store a reason (or multiple reasons) why access was denied at a particular access control device 140. Examples of reasons why access was denied can include invalid credentials, expired credentials, off-hours access limitations, suspected misuse of credentials (e.g., if a user device 120 was used to request access to two access control device 140 that are located relatively far apart within a relatively short period of time), and/or any other reason why access might be denied to a user device 120. In some embodiments, the reasons for denying access can be stored in access rules 114.

In some embodiments, the location history component 126 can receive a request from a user of user device 120 for a list of locations visited within a specified time window. Location history component 126 can identify the location(s) of access control device(s) 140 and their corresponding timestamps stored in user device 120, and can generate a list of locations visited within the specified time window. Location history component 126 can provide a visual representation of the location(s) visited within the specified time period, e.g., via a graphical user interface (GUI). In some embodiments, the GUI can display a map of the area including the access control device(s) 140 visited within the specified time period, and can indicate on the map the location(s) visited within the specified time window. For example, the GUI can display a map of a campus, which can include an indicator located at each location visited within the specified time window. In some embodiments, the indicator can indicate whether access was granted or denied. In some embodiments, the indicator can indicate the time that access was granted or denied. In some embodiments, a reason can be provided for why access was denied. In some embodiments, the GUI can display a list (rather than, or addition to, the map) of locations visited within the specified time period.

In some embodiments, the secondary application 128 can keep track of the location of the user device 120. The secondary application 128 can receive location information from client-side access application 124 and/or location history component 126, and can use the location information to update the location data of the user device 120 to correspond to the information identifying the location of the access control device 140.

In some embodiments, the secondary application 128 can receive and/or access the location information collected by location history component 126. The secondary application 128 can use the location information to improve its functionality. For example, the secondary application 128 can be a calendar application, and can use the location information to determine the precise location of the user device (e.g., through which door the user of the user device accessed a building). The calendar application can use this location information to provide directions to the user device to the next meeting on the calendar, to provide a notification that the user of the next scheduled meeting, to suggest a meeting room location, etc.

Server device 130 can include a server-side access application 134, and/or a location information component 136. In some embodiments, the server-side access application 134 can perform the functions of client-side access application 124 and/or the reader-side access application 144. In some embodiments, the server-side access application 134 can generate and/or provide a configuration file access control device 140 to configure the reader-side access application 144.

In some embodiments, the location information component 136 can enable a user device 120 and/or an access control device 140 to identify the location information of the access control device 140. In some embodiments, the location information component 136 can receive a request from user device 120 and/or access control device 140 for location information identifying the physical location of the access control device 140. Location information component 136 can use location data 112 in data store 110 to identify the physical location of the access control device 140, and can send the physical location information of the access control device 140 to the user device 120 and/or the access control device 140.

In situations in which the system discussed here collects personal information about users, or may make use of personal information, the users may be provided with an opportunity to control whether server device 130 and/or access control device 140 collects user information (e.g., personal information about the user, information about a user's location, a user's preferences, and/or any other personal information), or to control whether and/or how to receive content from the server device 130 that may be more relevant to the user. In addition, certain data may be treated in one or more ways before it is stored or used, so that personally identifiable information is removed. Thus, the user may have control over how information is collected about the user and used by server device 130, access control device 140, and/or user device 120.

FIG. 2 is a diagram illustrating an implementation of a method 200 to enable communication between a user device 120 and an access control device 140, according to at least one embodiment of the present disclosure. Method 200 may be performed by processing logic that includes hardware (e.g., circuitry, dedicated logic, programmable logic, microcode, etc.), software (e.g., instructions run on a processor to perform hardware simulation), or a combination thereof. Method 200 or each of its individual functions, routines, subroutines, or operations may be performed by one or more processors of a computer system (e.g., client device 120 (e.g., through client-side access application 124), server device 130 (e.g., through server-side access application 124), and/or access control device 140 (e.g., through reader-side access application 144) of FIG. 1) implementing the method. In an illustrative example, method 200 (or parts thereof) may be performed by a single processing thread. Alternatively, method 200 may be performed by two or more processing threads, each thread implementing one or more individual functions, routines, subroutines, or operations of the method. In an illustrative example, the processing threads implementing method 200 may be synchronized (e.g., using semaphores, critical sections, or other thread synchronization mechanisms).

For simplicity of explanation, the methods of this disclosure are depicted and described as a series of acts. However, acts in accordance with this disclosure can occur in various orders and/or concurrently, with other acts not presented and described herein. Furthermore, not all illustrated acts may be needed to implement the methods in accordance with the disclosed subject matter. In addition, it can be appreciated that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

Referring to FIG. 2, the process can begin with a user device 120 requesting access 202 to an access control device 140. A request for access can be sent via NFC, Bluetooth, RFID, Wi-Fi, and/or any other communication protocol. Thus, at operation 202, user device 202 can request access to access control device 140. In some embodiments, the request for access at operation 202 can be sent from communication component 122 of user device 120 of FIG. 1, and can be received by communication component 142 of access control device 140 of FIG. 1.

At operation 204, in response to receiving a request for access, access control device 140 can send an application ID to user device 120. The application ID can specify an application that the user device 120 can use to gain access to the area controlled by the access control device 140. For example, the application ID can correspond to client-side application 124. In some embodiments, the application ID can be part of a message received from access control device 140. The message can be sent by communication component 142 of access control device 140, or by reader-side access application 144 of access control device 140 of FIG. 1. The message can be received by communication component 122 of user device 120 of FIG. 1. In some embodiments, the message can include the location information of the access control device 140. For example, the message can include an ID of the access control device 140 (e.g., the access control device ID), a serial number of the access control device 140, a latitude and longitude coordinate of the physical location of the access control device 140, and/or a geolocation code of the physical location of the access control device 140. The location information identifying the physical location of the access control device 140 can be any information that the user device 120 can use to identify the physical location of the access control device 140 (e.g., an address, a building name or identifier, an indicator identifying the floor of the building, and/or any other such information).

In some embodiments, at operation 204, the access control device 140 can send the application ID to the user device 120 via a select command, instructing the receiver of the select command to launch the application corresponding to the application ID. In some embodiments, the configuration file received from server device 130 (as described with respect to FIG. 1) can include instructions to embed the location information of the access control device 140 within the select command. For example, the configuration file can extend the application ID to include the location information of the access control device 140. For example, the application ID can be a parameter that is sent with the select command, and the configuration file can modify the application ID parameter to include the application ID as well as information identifying the location of the access control device 140.

Upon receiving the message that specifies the application ID, user device 120 can launch the corresponding application (e.g., client-side access application 124). In some embodiments, the client-side application 124 can identify the information identifying the location of the access control device 140 in the application ID parameter. The client-side application 124 can store the information identifying the location of the access control device 140, along with a timestamp indicating the time the information was received by the user device 120.

At operation 206, access control device 140 (e.g., via reader-side access application 144) can request identification of the user device 120. In some embodiments, the access control device 140 can request a card holder user ID (CHUID) from the user device 120. The CHUID can identify the user of the user device 120. In some embodiments, the access control device 140 can request another form of identification from the user device 120.

At operation 208, in response to receiving the request for identification of user device 120, the user device 120 (e.g., via client-side access application 124) can send a user identification associated with the user device 120. In some embodiments, the user identification can be a CHUID. In some embodiments, the user identification can be another form of identification, such as a username, employee number, or some other form of identifying data. In some embodiments, the access control device 140 (e.g., via reader-side access application 144) can access data store 110 (e.g., access rules 114) to determine the access privileges corresponding to the identification of the user device 120.

At operation 210, the access control device 140 can send a sign challenge to the user device 120. A sign challenge, sometimes referred to as a challenge-response authentication, is a security protocol that can verify the identity of an entity making a request by checking if the entity can produce the correct response to the challenge. The authenticating system (e.g., the access control device 140) can present a challenge to the entity requesting access (e.g., the user device 120). In some embodiments, the challenge can be a randomly (or pseudo-randomly) generated number or string of text. For example, the challenge can be a nonce (e.g., a 32-byte nonce).

In some embodiments, the information identifying the location of the access control device 140 can be embedded as part of the authentication challenge. For example, the location information of the access control device 140 can be embedded as part of the nonce. In some embodiments, the configuration file received from server device 130 (as described with respect to FIG. 1) can include instructions to embed the location information of the access control device 140 in the nonce. In some embodiments, upon receiving the authentication challenge, the user device 120 can identify the location information embedded in the authentication challenge. The user device 120 can extract the location information of the access control device 140, and can store the extracted location information along with a timestamp of the time the location information was received.

At operation 212, the user device 120 can generate a response to the challenge, e.g. using a secret key. For example, the user device 120 can sign the challenge (e.g., the nonce) using a private key in a public/private key pair. Generating the response to the challenge can involve cryptographic operations that uniquely combine the challenge with the secret (or private) key. At operation 214, the user device 120 can send the generated response (e.g., the signed nonce) to the access control device 140.

At operation 216, the access control device 140 can determine whether to grant access, based on the received authentication challenge response. That is, the access control device 140 can verify that the response is correct. For example, the access control device 140 can use a public key to verify that the response was signed with the correct private key corresponding to the identification of the user device 120 sent at operation 208. In response to determining that the response to the authentication challenge is correct, the access control device 140 can grant access to the user device 120. In response to determining that the response to the authentication challenge is incorrect, the access control device 140 can deny access to the user device 120. In some embodiments, the access control device 140 can send a reason for denying access to the user device 120. In some embodiments, user device 120 can store the grant or denial of access, optionally including the reason for denial of access if applicable.

In some embodiments, the access control device 140 can optionally perform operation 218. At operation 218, the access control device 140 can send a message that includes the location information of the access control device 140. In some embodiments, the communication protocol between user device 120 and access control device 140 can use application data protocol units (APDU) to communicate.

An APDU is a data unit or message format used for communication between a host system (e.g., access control device 140) and an embedded device (e.g., a smart card). A smart card can contain an embedded microchip that can store and process data, and can be used in a variety of contexts (e.g., payment cards, electronic passports, identification cards, etc.). The subscriber identify module (SIM) card in a mobile device (e.g., user device 120) can be a smart card. APDUs can be used to transmit commands from the host to the smart card, and to receive responses from the smart card. An APDU can be a command APDU that contains information sent from the host to the smart card, including details such as the command code, data to be processed by the card, and other control information. An APDU can be a response APDU that contains the response from the smart card to the host, and can include the status indicating the success or failure of the command execution, and any data or information requested or generated by the smart card.

In some embodiments, the configuration file received from server device 130 (as described with respect to FIG. 1) can include instructions to create a new APDU, in which to include the location information of the access control device 140. In some embodiments, at operation 128, the access control device 140 can send a command APDU to the user device 120. The command APDU can include the location information of the access control device 140. In response to receiving the command APDU from the access control device 140, the user device 120 can extract and/or store the location information included in the APDU command. Optionally, the user device 120 can send a response APDU to the access control device 140, indicating the status (e.g., the success or failure of the user device extracting and/or storing the location information included in the command APDU). It should be noted that the message format sent from the access control device 140 at operation 128 is not limited to APDU format.

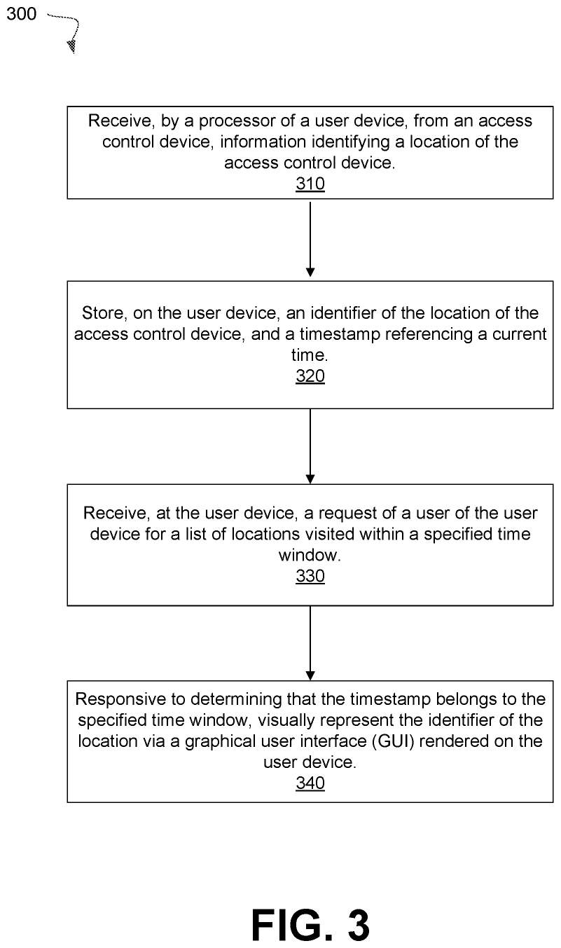

FIG. 3 is a flow diagram of an example method 300 for tracking location information by a user device, according to at least one embodiment. Method 300 can be performed by processing logic that can include hardware (circuitry, dedicated logic, etc.), software (e.g., instructions run on a processing device), or a combination thereof. In at least one implementation, some or all of the operations of method 300 can be performed by one or more components of user device 120 of FIG. 1. In other implementations, some or all of the operations of method 300 can be performed by one or more components of server device 130, and/or access control device 140 of FIG. 1.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states, e.g., via a state diagram. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-related device or storage media.

At block 310, processing logic processing logic receives, from an access control device (e.g., access control device 140), information identifying a location of the access control device. The information identifying the location of the access control device can include an access control device ID, a serial number of the access control device, a latitude and longitude coordinate, and/or a geolocation code.

In some embodiments, receiving the information identifying the location of the access control device can include sending, to the access control device, a first request to access the access control device. Processing logic can receive, from the access control device, a message that includes an application ID of an application (e.g., client-side access application 124) to communicate with the access control device and the information identifying the location of the access control device. The application can be hosted by the user device. In some embodiments, the message can be a select command sent from the access control device. The select command can include the application ID, and can instruct the processing logic to select the application corresponding to the application ID to facilitate communications with the access control device. In some embodiments, the application ID can be extended to include the information identifying the location of the access control device. Processing logic can receive, from the access control device, a second request for an identification of the user device. Responsive to receiving the second request, processing logic can send, to the access control device, a user identification associated with the user device. Processing logic can receive, from the access control device, a nonce. Processing logic can generate a signed nonce by signing the nonce with a private key, and can send the signed nonce to the access control device to allow the access control device to authenticate the user device.

In some embodiments, receiving the information identifying the location of the access control device can include sending, to the access control device, a first request to access the access control device. Processing logic can then receive, from the access control device, an application ID of an application (e.g., client-side access application 124) to communicate with the access control device. The application can be hosted by the user device. Processing logic can receive, from the access control device, a second request for an identification of the user device. Responsive to the second request, processing logic can send, to the access control device, a user identification associated with the user device. Processing logic can receive, from the access control device, a nonce with the information identifying the location of the access control device. That is, the information identifying the location of the access control device can be embedded as part of the nonce. The processing logic can extract the information identifying the location of the access control device from the nonce, and can store the information on the user device. Processing logic can generate a signed nonce by signing the nonce with a private key, and can send the signed nonce to the access control device to allow the access control device to authenticate the user device.

In some embodiments, receiving the information identifying the location of the access control device can include sending, to the access control device, a first request to access the access control device. Processing logic can then receive, from the access control device, an application ID of an application (e.g., client-side access application 124) to communicate with the access control device. The application can be hosted by the user device. Processing logic can receive, from the access control device, a second request for an identification of the user device. Responsive to the second request, processing logic can send, to the access control device, a user identification associated with the user device. Processing logic can receive, from the access control device, a nonce. Processing logic can generate a signed nonce by signing the nonce with a private key, and can send the signed nonce to the access control device to allow the access control device to authenticate the user device. Processing logic can receive, from the access control device and using the application, an application protocol data unit (APDU) that includes the information identifying the location of the access control device. For example, the APDU can be a command message that instructs the processing logic to extract and/or store the information identifying the location of the access control device.

At block 320, processing logic stores, on the user device, an identifier of the location of the access control device, and a timestamp referencing a current time. Processing logic can store the identifier of the location of the access control device and the corresponding timestamp referencing the current time in a data structure on the user device. In some embodiments, the identifier of the location of the access control device can be an access control device ID, a serial number of the access control device, a latitude and longitude coordinate, and/or a geolocation code. In some embodiments, the identifier can be a unique identifier that identifies the access control device, and processing logic can look-up the location of the access control device using the identifier.

At block 330, processing logic receives, at the user device, a request of a user of the user device for a list of locations visited within a specified time window. In some embodiments, the request can be received through a graphical user interface, and the user can specify the time window. In some embodiments, the request can be received from an application hosted by the user device (e.g., secondary application 128 of FIG. 1), and the application can provide the specified time window.

At block 340, responsive to determining that the timestamp belongs to the specified time window, processing logic visually represents the identifier of the location via a graphical user interface (GUI) rendered on the user device. In some embodiments, processing logic identifies a plurality of identifiers of locations stored on the user device with timestamps belonging to the specified time window. Processing logic can display a user interface in the GUI with the identified plurality of identifiers including the identifier of the location of the access control device. In some embodiments, the GUI can present a map of the area in which the user device is located (or was located during the specified time window), and can indicate on the map the location(s) of the access control device(s) accessed within the specified time window. In some embodiments, the GUI can present a location regardless of whether access was granted, and can optionally include an indication of whether access was granted or denied. In some embodiments, the GUI can present the timestamps corresponding to each location identifier.

In some embodiments, processing logic can update location data of the user device to correspond to the information identifying the location of the access control device. That is, processing logic can use the information identifying the location of the access control device to calibrate the location data of the user device.

In some embodiments, processing logic can send the information identifying the location of the access control device to a second application hosted by the user device (e.g., secondary application 128 of FIG. 1). Processing logic can receive, from the second application, additional data corresponding to the location of the access control device. Processing logic can provide the additional data for display in the GUI rendered on the user device. For example, the application running on the user device can be a location-based services application, and can provide additional information related to the location of the access control device, such as nearby restaurants or cafeterias, weather forecasts, events, meeting locations, etc. For example, the application hosted by the user device can be a calendar application, and can identify a meeting on the user's calendar that is scheduled to occur near the current time, and/or is located near the information identifying the location of the access control device. In this example, the second application (e.g., the calendar application) can provide the meeting details (e.g., location, start time, end time, and/or attendees, etc.) to the application hosted by the user device, which can provide the additional data (e.g., the meeting details) corresponding to the location of the access control device. As another illustrative example, the second application can be an activity tracker, and the additional data can correspond to activity measured and/or recorded by the activity tracker that corresponds to the location of the access control device.

FIG. 4 is a block diagram illustrating an exemplary computer system 400, in accordance with at least one embodiment of the present disclosure. The computer system 400 can correspond to server device 130, access control device 140, and/or user device 120 in FIG. 1. The machine can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processing device (processor) 402, a main memory 404 (e.g., volatile memory, read-only memory (ROM), flash memory, dynamic random access memory (DRAM) such as synchronous DRAM (SDRAM), double data rate (DDR SDRAM), or DRAM (RDRAM), etc.), a static memory 406 (e.g., non-volatile memory, flash memory, static random access memory (SRAM), etc.), and a data storage device 416, which communicate with each other via a bus 430.

Processor (processing device) 402 represents one or more general-purpose processing devices such as a microprocessor, central processing unit, or the like. More particularly, the processor 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 can also be one or more special-purpose processing devices such as an application specific integrated circuit (ASIC), a field programmable gate array (FPGA), a digital signal processor (DSP), network processor, or the like. The processor 402 is configured to execute instructions 426 (e.g., for tracking the location of a device) for performing the operations discussed herein.

The computer system 400 can further include a network interface device 408. The computer system 400 also can include a video display unit 410 (e.g., a liquid crystal display (LCD) or a cathode ray tube (CRT)), an input device 412 (e.g., a keyboard, and alphanumeric keyboard, a motion sensing input device, touch screen), a cursor control device 414 (e.g., a mouse), and a signal generation device 418 (e.g., a speaker).

The data storage device 416 can include a non-transitory machine-readable storage medium 424 (also computer-readable storage medium) on which is stored one or more sets of instructions 426 (e.g., for tracking the location of a device) embodying any one or more of the methodologies or functions described herein. The instructions can also reside, completely or at least partially, within the main memory 404 and/or within the processor 402 during execution thereof by the computer system 400, the main memory 404 and the processor 402 also constituting machine-readable storage media. The instructions can further be transmitted or received over a network 420 via the network interface device 408.

In one implementation, the instructions 426 include instructions for tracking the location of a device, e.g., based on communications with an access control device. While the computer-readable storage medium 424 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
receiving, by a processor of a user device, from an access control device, information identifying a location of the access control device;
storing, on the user device, an identifier of the location of the access control device, and a timestamp referencing a current time;
receiving, at the user device, a request of a user of the user device for a list of locations visited within a specified time window; and
responsive to determining that the timestamp belongs to the specified time window, visually representing the identifier of the location via a graphical user interface (GUI) rendered on the user device.

2. The method of claim 1, wherein visually representing the identifier of the location via the GUI rendered on the user device comprises:
identifying a plurality of identifiers of locations stored on the user device with timestamps belonging to the specified time window; and
displaying the GUI with the identified plurality of identifiers comprising the identifier of the location of the access control device.

3. The method of claim 1, wherein the information identifying the location of the access control device comprises at least one of: an access control device ID, a serial number of the access control device, a latitude and longitude coordinate, or a geolocation code.

4. The method of claim 1, further comprising:
updating location data of the user device to correspond to the information identifying the location of the access control device.

5. The method of claim 1, wherein receiving, from the access control device, the information identifying the location of the access control device further comprises:
sending, to the access control device, a first request to access the access control device;
receiving, from the access control device, a message comprising an application ID of an application to communicate with the access control device and the information identifying the location of the access control device, wherein the application is hosted by the user device;
receiving, from the access control device, a second request for an identification of the user device;
responsive to the second request, sending, to the access control device, a user identification associated with the user device;
receiving, from the access control device, a nonce;
generating a signed nonce by signing the nonce with a private key; and
sending the signed nonce to the access control device to allow the access control device to authenticate the user device.

6. The method of claim 1, wherein receiving, from the access control device, the information identifying the location of the access control device further comprises:
sending, to the access control device, a first request to access the access control device;
receiving, from the access control device, an application ID of an application to communicate with the access control device, wherein the application is hosted by the user device;
receiving, from the access control device, a second request for an identification of the user device;
responsive to the second request, sending, to the access control device, a user identification associated with the user device;
receiving, from the access control device, a nonce with the information identifying the location of the access control device;
generating a signed nonce by signing the nonce with a private key; and
sending the signed nonce to the access control device to allow the access control device to authenticate the user device.

7. The method of claim 1, wherein receiving, from the access control device, the information identifying the location of the access control device further comprises:
sending, to the access control device, a first request to access the access control device;
receiving, from the access control device, an application ID of an application to communicate with the access control device, wherein the application is hosted by the user device;
receiving, from the access control device, a second request for an identification of the user device;
responsive to the second request, sending, to the access control device, a user identification associated with the user device;
receiving, from the access control device, a nonce;
generating a signed nonce by signing the nonce with a private key;
sending the signed nonce to the access control device to allow the access control device to authenticate the user device; and
receiving, from the access control device and using the application, an application protocol data unit comprising the information identifying the location of the access control device.

8. The method of claim 1, further comprising:
sending the information identifying the location of the access control device to a second application hosted by the user device;
receiving, from the second application, additional data corresponding to the location of the access control device; and
providing the additional data for display in the GUI rendered on the user device.

9. A system comprising:
a memory device; and
a processing device coupled to the memory device, the processing device to perform operations comprising:
receiving, by a user device, from an access control device, information identifying a location of the access control device;
storing, on the user device, an identifier of the location of the access control device, and a timestamp referencing a current time;
receiving, at the user device, a request of a user of the user device for a list of locations visited within a specified time window; and
responsive to determining that the timestamp belongs to the specified time window, visually representing the identifier of the location via a graphical user interface (GUI) rendered on the user device.

10. The system of claim 9, wherein visually representing the identifier of the location via the GUI rendered on the user device comprises:
identifying a plurality of identifiers of locations stored on the user device with timestamps belonging to the specified time window; and
displaying the GUI with the identified plurality of identifiers comprising the identifier of the location of the access control device.

11. The system of claim 10, wherein the information identifying the location of the access control device comprises at least one of: an access control device ID, a serial number of the access control device, a latitude and longitude coordinate, or a geolocation code.

12. The system of claim 10, wherein the operations further comprise:
updating location data of the user device to correspond to the information identifying the location of the access control device.

13. The system of claim 10, wherein receiving, from the access control device, the information identifying the location of the access control device further comprises:
sending, to the access control device, a first request to access the access control device;
receiving, from the access control device, a message comprising an application ID of an application to communicate with the access control device and the information identifying the location of the access control device, wherein the application is hosted by the user device;
receiving, from the access control device, a second request for an identification of the user device;
responsive to the second request, sending, to the access control device, a user identification associated with the user device;
receiving, from the access control device, a nonce;
generating a signed nonce by signing the nonce with a private key; and
sending the signed nonce to the access control device to allow the access control device to authenticate the user device.

14. The system of claim 10, wherein receiving, from the access control device, the information identifying the location of the access control device further comprises:
sending, to the access control device, a first request to access the access control device;
receiving, from the access control device, an application ID of an application to communicate with the access control device, wherein the application is hosted by the user device;
receiving, from the access control device, a second request for an identification of the user device;
responsive to the second request, sending, to the access control device, a user identification associated with the user device;
receiving, from the access control device, a nonce with the information identifying the location of the access control device;
generating a signed nonce by signing the nonce with a private key; and
sending the signed nonce to the access control device to allow the access control device to authenticate the user device.

15. The system of claim 10, wherein receiving, from the access control device, the information identifying the location of the access control device further comprises:
sending, to the access control device, a first request to access the access control device;
receiving, from the access control device, an application ID of an application to communicate with the access control device, wherein the application is hosted by the user device;
receiving, from the access control device, a second request for an identification of the user device;
responsive to the second request, sending, to the access control device, a user identification associated with the user device;
receiving, from the access control device, a nonce;
generating a signed nonce by signing the nonce with a private key;
sending the signed nonce to the access control device to allow the access control device to authenticate the user device; and
receiving, from the access control device and using the application, an application protocol data unit comprising the information identifying the location of the access control device.

16. The system of claim 10, wherein the operations further comprise:
sending the information identifying the location of the access control device to a second application hosted by the user device;
receiving, from the second application, additional data corresponding to the location of the access control device; and
providing the additional data for display in the GUI rendered on the user device.

17. A non-transitory computer readable storage medium comprising instructions for a server that, when executed by a processing device, cause the processing device to perform operations comprising:
receiving, by a processor of a user device, from an access control device, information identifying a location of the access control device;
storing, on the user device, an identifier of the location of the access control device, and a timestamp referencing a current time;
receiving, at the user device, a request of a user of the user device for a list of locations visited within a specified time window; and
responsive to determining that the timestamp belongs to the specified time window, visually representing the identifier of the location via a graphical user interface (GUI) rendered on the user device.

18. The non-transitory computer readable storage medium of claim 17, receiving, from the access control device, the information identifying the location of the access control device further comprises:
sending, to the access control device, a first request to access the access control device;
receiving, from the access control device, a message comprising an application ID of an application to communicate with the access control device and the information identifying the location of the access control device, wherein the application is hosted by the user device;
receiving, from the access control device, a second request for an identification of the user device;
responsive to the second request, sending, to the access control device, a user identification associated with the user device;
receiving, from the access control device, a nonce;
generating a signed nonce by signing the nonce with a private key; and
sending the signed nonce to the access control device to allow the access control device to authenticate the user device.

19. The non-transitory computer readable storage medium of claim 17, wherein receiving, from the access control device, the information identifying the location of the access control device further comprises:
sending, to the access control device, a first request to access the access control device;
receiving, from the access control device, an application ID of an application to communicate with the access control device, wherein the application is hosted by the user device;
receiving, from the access control device, a second request for an identification of the user device;
responsive to the second request, sending, to the access control device, a user identification associated with the user device;
receiving, from the access control device, a nonce with the information identifying the location of the access control device;
generating a signed nonce by signing the nonce with a private key; and
sending the signed nonce to the access control device to allow the access control device to authenticate the user device.

20. The non-transitory computer readable storage medium of claim 17 wherein receiving, from the access control device, the information identifying the location of the access control device further comprises:
sending, to the access control device, a first request to access the access control device;
receiving, from the access control device, an application ID of an application to communicate with the access control device, wherein the application is hosted by the user device;
receiving, from the access control device, a second request for an identification of the user device;
responsive to the second request, sending, to the access control device, a user identification associated with the user device;
receiving, from the access control device, a nonce;
generating a signed nonce by signing the nonce with a private key;
sending the signed nonce to the access control device to allow the access control device to authenticate the user device; and
receiving, from the access control device and using the application, an application protocol data unit comprising the information identifying the location of the access control device.
